(19) United States
(12) Patent Application Publication
(10) Pub. No.: US 2005/0216600 A1
(43) Pub. Date: Sep. 29, 2005

(54) System and method for providing a service in a controlled run-time environment

(76) Inventor: Jonathan Maron, Marlton, NJ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/807,060

(22) Filed: Mar. 23, 2004

(51) Int. Cl. G06F 15/173; G06F 15/16

(52) U.S. Cl. 709/236; 709/224

(57) ABSTRACT

A method for providing a service in a controlled run-time environment. The method comprises registering a proxy service in the controlled run-time environment wherein the proxy service implements an interface defined according to the controlled run-time environment to enable services operating in the controlled run-time environment to interoperate with the service, receiving service information by the proxy service from a local service executing in the controlled run-time environment via an interface method of the proxy service, communicating the service information to a remote service from the proxy service, receiving processed information from the remote service in response to the communicating, and returning the processed information to the local service from the proxy service.

### BACKGROUND

An enterprise application is a qualitative term used to describe a software application designed to execute under relatively demanding performance criteria and to support a relatively large number of distributed users in a scalable manner. The development of enterprise applications may be relatively difficult due to their robust functionality and performance requirements. Enterprise applications are typically implemented utilizing an application server architecture. The various services of the application server architecture are deployed on the applications server by writing the software code (e.g., the object oriented class files) on a storage device associated with the application server and by modifying an appropriate deployment descriptor. In general, all of the modular software functionality of an application server is stored locally on the processing platform that executes the application server.

In addition to conventional application servers, distributed web servers may be developed to enable remote services to be assembled into an application. Various protocols have been developed for the purpose of implementing remote web services such as the Web Services Description Language (WSDL). WSDL defines interfaces and invocation methods of a web service. Further, WSDL describes publication of web services to Intranet or Internet repositories or registries to enable identification and location of web services. The location and identification of web services may occur utilizing Universal Description, Discovery, and Integration (UDDI). Communication with web services may utilize various protocols such as Remote Procedure Calls (RPC). For example, JAX-RPC is the JAVA™ remote procedure call technology. JAX-RPC enables JAVA™ developers to build Web applications and Web services. The RPC mechanism enables a remote procedure call from a client to be communicated to a remote server. In a distributed client/server model, for example, a server defines a service as a collection of procedures that are callable by remote clients. A client calls the remote procedures on the server to access services defined by the server. In extensible mark-up language (XML)-based RPC, a remote procedure call is represented using an XML-based protocol such as the Simple Object Access Protocol (SOAP) 1.1 specification which defines a convention for representation of remote procedure calls and responses.

Integrating distributed web services into an application presents numerous complications. Some of the more important complications are authentication and identity-management. As an example, “single sign-on” facilities have been contemplated. The difficulty of such single sign-on facilities is the propagation of the associated security context from distributed web service to distributed web service. The importance of this implementation issue is evident in the observation that a single web service that propagates a compromised security context may compromise numerous other web services.

### SUMMARY

In one embodiment, a method for providing a service in a controlled run-time environment is disclosed. The method comprises registering a proxy service in the controlled run-time environment wherein the proxy service implements an interface defined according to the controlled run-time environment to enable services operating in the controlled run-time environment to interoperate with the service, receiving service information by the proxy service from a local service executing in the controlled run-time environment via an interface method of the proxy service, communicating the service information to a remote service from the proxy service, receiving processed information from the remote service in response to the communicating, and returning the processed information to the local service from the proxy service.

In another embodiment, a system for providing a modular software service is disclosed. The system comprises controlled run-time environment means for managing processes, service registry means for registering services operating in the controlled run-time environment means, wherein at least one registered service is a proxy service means, the proxy service means implementing an interface defined according to the controlled run-time environment means for enabling services operating in the controlled run-time environment means to interoperate with the proxy service means, the proxy service means comprising: means for receiving service information by the proxy service means from a local service executing in the controlled run-time environment means, means for communicating the service information to a remote service from the proxy service means, means for receiving processed information from the remote service in response to the communicated service information; and means for returning the processed information to the local service.

In yet another embodiment, a computer-readable medium that comprises executable instructions for providing a service in a controlled run-time environment is disclosed. The executable instructions of the computer readable medium comprise: code for registering a proxy service in the controlled run-time environment wherein the proxy service implements an interface defined according to the controlled run-time environment to enable services operating in the controlled run-time environment to interoperate with the service, code for receiving service information by the proxy service from a local service executing in the controlled run-time environment via a method of the proxy service, code for communicating the service information to a remote service from the proxy service, code for receiving processed information from the remote service in response to the communicating, and code for returning the processed information to the local service from the proxy service.

### BRIEF DESCRIPTION OF THE DRAWINGS

FIG. 1 depicts an architecture for execution of an enterprise application.

FIG. 2 depicts an application server.

FIG. 3 depicts an application server according to representative embodiments.

FIG. 4 depicts a flowchart according to representative embodiments.

FIG. 5 depicts a computer system that may implement representative embodiments.

### DETAILED DESCRIPTION

Before discussing representative embodiments in greater detail, it is appropriate to discuss the operations of the architecture that is typically utilized to implement enterprise applications. FIG. 1 depicts system 100 that may be utilized to implement enterprise applications. System 100 comprises client 101 in the client tier. Client 101 may comprise browser 104 to enable client 101 to access the enterprise applications. Alternatively, stand-alone application 105 may be implemented to access the enterprise applications in a proprietary manner if appropriate for the nature of the enterprise applications. The client tier is, in general, responsible for providing a user with the facilities (e.g., graphical user interfaces) that are necessary to interact with the applications on the middle tier. Enterprise Information System (EIS) 103 in the EIS tier may be implemented to manage the data utilized by the enterprise applications. EIS 103 may store the enterprise data in database 106 utilizing relational database management functionality as an example.

In the middle tier, Application Server (AS) 102 may interact with both client 101 and EIS 103. For example, AS 102 may comprise container 107 (such as an Enterprise JAVA Bean™ (EJB)) to facilitate access to EIS 103. A container is a controlled run-time environment for an application component that also provides an interface to components executing within the container. Also, containers provide basic management functionality such as life cycle management of the components, security, deployment, threading, and/or the like. An EJB is a software component that implements the interfaces defined by its respective container. The interfaces of the EJB are defined in a manner that permits the functionality of the respective EJB to be accessed in a modular and dynamic manner. As shown in FIG. 1, AS 102 may also comprise web container 108. Web container 108 may provide a controlled run-time environment for components that interact with client 101. For example, servlet components (persistent web server processes that are capable of processing multiple requests) may be implemented to dynamically create hypertext markup language (HTML) or XML responses to requests from client 101. Other suitable components may be implemented within web container 108.

In general, AS 102 (the middle tier) may be implemented utilizing “middleware servers” or “application servers.” An application server is typically comprised of many dissimilar services that are appropriate to create a stable and robust environment for enterprise applications. A service represents a predefined task that is provided by a piece of software in a well defined and predicable manner. Typically, an application server may comprise services that implement management functionality. The management services of the application server may be responsible for starting, registering, monitoring, and stopping services. Management services may perform other tasks such as thread pooling, security management, state management, class loading, load-balancing, dynamic application launching, and/or the like. Secondly, an application server may provide a basic set of services that may be commonly utilized by a wide range of enterprise applications (e.g., hypertext transfer protocol (HTTP) processing). Third, an application server may comprise application specific services that implement the business or other logic of a given enterprise application.

In general, the management functionality of an application server may enable an enterprise application to be implemented by binding the application specific services to more general services. For example, the management functionality may utilize a suitable deployment descriptor to create an HTTP listening service on a given port and to pass HTTP requests received from that port to an application specific service. The processing of the HTTP requests by the application specific service may then be managed by security services, event logging services, load-balancing services, and/or the like.

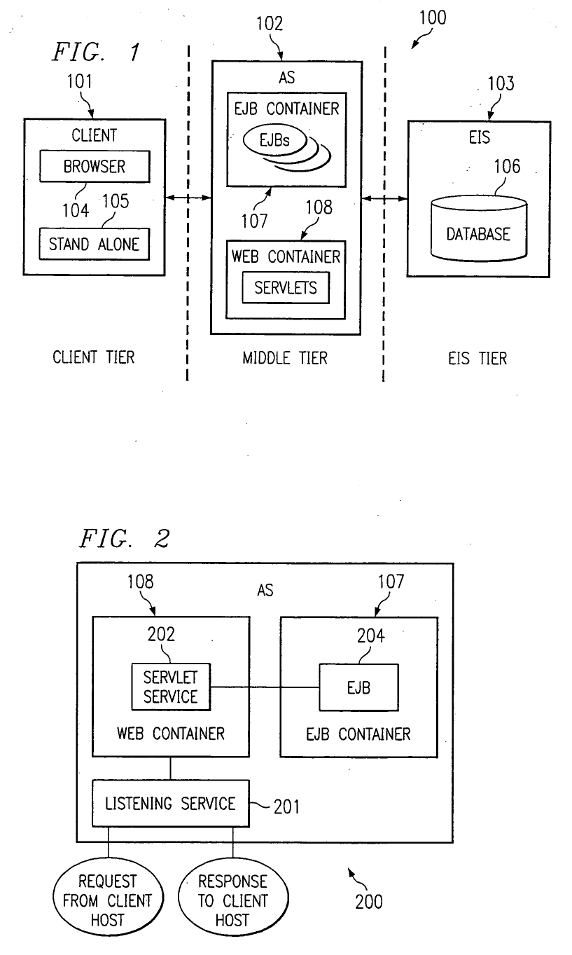

FIG. 2 depicts application server (AS) 200 that implements an enterprise application. AS 200 receives and processes requests from clients and returns responses to the respective clients. AS 200 may comprise listening service 201 to manage communication of the requests and responses. For example, a hypertext transfer protocol (HTTP) service may be defined to receive HTTP transactions on a defined port. Listening service 201 may pass the processed HTTP information to servlet service 202 that executes in web container 108. Servlet service 202 may perform the application specific tasks. For example, servlet service 202 may generate HTML forms to facilitate communication of user specific information. Servlet service 202 may process the communicated user specific information. Servlet service 202 may then store the processed user specific information in a suitable database utilizing EJB 204 that is associated with EJB container 107.

The ability to create an enterprise application from a plurality of independent services is facilitated by defining standardized interfaces and contracts. Specifically, the standardized interfaces define a collection of methods to be implemented by a class to expose the class to interaction within the application server environment. The contracts define special purpose interfaces that describe the syntax and semantics of class behavior. By defining interfaces and contracts in this maimer, application server 200 may enable distinct services to interact thereby permitting programmatic solutions that are common to multiple business solutions to be assembled and reused for multiple applications.

Representative embodiments depart from known application server designs by permitting resources on remote systems to be assembled into an enterprise application while maintaining the service architecture. By making remote services locally accessible and by maintaining the service architecture, development of an application through assembly utilizing remote services becomes advantageous. Specifically, the security management services, logging services, and other services of the run-time environment may be leveraged to provide such facilities to the provision of remote services with reduced complexity. Thus, the complexity and unreliability of distributed web service assembly may be remedied.

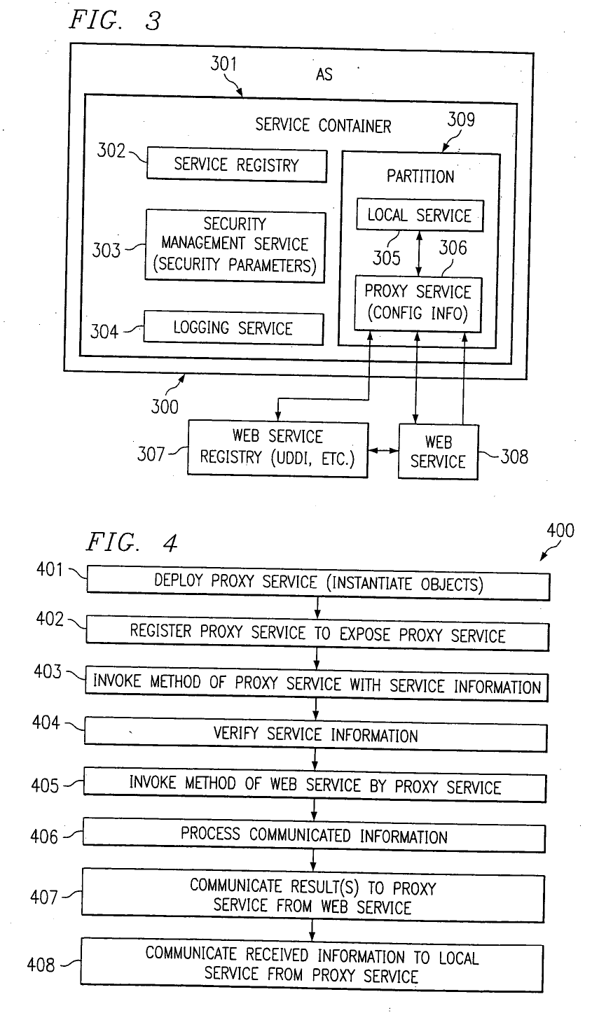

FIG. 3 depicts application server 300 that includes proxy service 306 according to representative embodiments. Application server 300 enables a plurality of services to be assembled into enterprise applications. The enterprise applications (not shown) may execute in a controlled run-time environment such as container 301. The services executing with container 301 may be contained within respective partitions (e.g., partition 309) to limit the ability of the services to access the functionality of other services to the functionality assigned to a particular partition.

Application server 300 may comprise service registry 302 to permit interoperation between services of enterprise applications. Specifically, processes that implement the defined interfaces of the controlled run-time environment may be registered in service registry 302 to expose their methods to other services. The other services may, in turn, examine service registry 302 to determine the availability of other services and to obtain an instance or handle to the interface of available services.

Additionally, application server 300 includes various services that facilitate administration of enterprise applications. For example, application server 300 comprises security management service 303. Security management service 303 may be operable to perform authentication, authorization, administration, and auditing requirements. For example, security management process 303 may authenticate users before permitting access to enterprise applications and enforce user level or process level restrictions within executed enterprise applications according to security parameters. Also, application server 300 comprises logging service 304. Logging service 304 may be operable when a service invokes a method of proxy service 306. Logging service 304 may, in response thereto, create a record of the calling service, the called service, the user context, the nature of the invoked method, any associated resources (e.g., files, communication addresses/ports, etc.), the time of the transaction, and/or the like. The recorded information may be subsequently utilized to determine whether users are accessing appropriate resources and whether unauthorized individuals have compromised the security of an enterprise application. The logged information may be used to facilitate intrusion detection and “post-mortem” intrusion analysis.

Application server 300 further comprises proxy service 306. Proxy service 306 may comprise or be associated with configuration information. Proxy service 306 may utilize the configuration information to communicate with web service registry 307 (e.g., a UDDI registry or the like). Proxy service 306 may perform such communication to obtain an instance of web service 308. Specifically, the instance of web service 308 may be associated with an object on which methods may be invoked by proxy service 306. By invoking the methods in this manner, proxy service 306 may access the functionality of web service 308. In representative embodiments, proxy service 306 may utilize JAX-RPC to invoke the methods of web service 308. Also, the methods may communicate the method argument(s) and returned argument(s) utilizing suitable protocols such as XML according to the SOAP specification.

As previously noted, application server 300 comprises service registry 302 to enable processes to expose their methods to other services. In representative embodiments, proxy service 306 may be registered in service registry 302. Other services, such as local service 305, may utilize the information contained in service registry 302 to access the exposed methods. Accordingly, local service 305 or a component residing therein may invoke an appropriate method or methods of proxy service 306 in the same manner as invoking a method of any other service executing within the controlled run-time environment of service container 301. When a method of proxy service 306 is invoked, method arguments may be communicated. Utilizing the communicated information, proxy service 306 may determine whether the arguments are appropriate given the method called. If so, proxy service 306 may invoke a corresponding method of web service 308 utilizing, for example, the method arguments communicated by local service 305. Proxy service 306 may manage the communication of information with web service 308 according to the respective communication protocols associated with web service 308. When the information is received by the method of web service 308, the method may process the information as appropriate (e.g., perform a database transaction). The method may return any appropriate information (e.g., an object containing the results of the database transaction) to proxy service 306. Proxy service 306 may communicate the returned information to local service 305.

FIG. 4 depicts flowchart 400 according to representative embodiments. In step 401 of flowchart 400, proxy service 306 may be deployed. For example, the respective object-oriented class file(s) defining the functionality of proxy service 306 may be stored on a storage medium accessible by application server 300. A suitable deployment descriptor or descriptors may be added and/or modified to cause object instances of the defined class or classes of web service 308 to be loaded and executed (i.e., instantiated) within the controlled run-time environment of service container 301.

In step 402, proxy service 306 may be registered within service registry 302 to expose its methods to other services. As previously noted, an interface may refer to the methods that a class implements to interoperate within the controlled run-time environment of service container 301. In step 403, one of the methods of the interface of proxy service 306 may be invoked by local service 305. The invocation of the method may communicate requested service information. Specifically, the arguments associated with the service request may be communicated according to the functionality of the programmatic environment utilized to implement local service 305 and proxy service 306. In step 404, proxy service 306 may verify the communicated service information. For example, the arguments containing the information may be verified against validity requirements. By doing so, an exception may be returned to local service 305 without wasting communication resources by communicating invalid arguments to web service 308.

In step 405, proxy service 306 may invoke a method of web service 308 utilizing an appropriate protocol. For example, the requested service information received from local service 305 may be encapsulated in an XML file and communicated to web service 308 via a suitable communication network (not shown). In step 406, web service 308 may process the communicated information. For example, web service 308 may utilize the information to perform a database transaction. The result(s) of the transaction may then be communicated to proxy service 306 (step 407). In step 408, proxy service 306 may communicate the received processed information to local service 305.

When implemented via executable instructions, various elements of representative embodiments are in essence the code defining the operations of such various elements. For example, the process flow of flowchart 400 may be implemented utilizing executable instructions or code. The executable instructions or code may be obtained from a readable medium (e.g., hard drive media, optical media, EPROM, EEPROM, tape media, cartridge media, and/or the like) or communicated via a data signal from a communication medium (e.g., the Internet). In fact, readable media can include any medium that can store or transfer information.

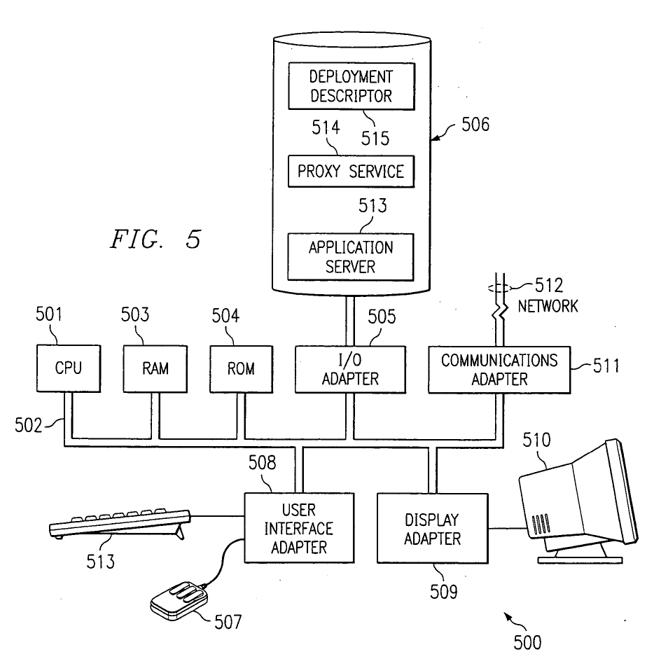

FIG. 5 illustrates computer system 500 adapted according to representative embodiments. Central processing unit (CPU) 501 is coupled to system bus 502. CPU 501 may be any general purpose CPU. However, the present invention is not restricted by the architecture of CPU 501 as long as CPU 501 supports the operations as described herein.

Computer system 500 also includes random access memory (RAM) 503, which may be SRAM, DRAM, SDRAM, or the like. Computer system 500 includes ROM 504 which may be PROM, EPROM, EEPROM, or the like. RAM 503 and ROM 504 hold user and system data and programs as is well known in the art.

Computer system 500 also includes input/output (I/O) adapter 505, communications adapter 511, user interface adapter 508, and display adapter 509. I/O adapter 505 connects to storage devices 506, such as one or more of hard drive, CD drive, floppy disk drive, tape drive, to computer system 500. The storage media associated with storage devices 506 may store executable instructions according to representative embodiments. For example, the executable instructions defining application server 513 may be stored on the media. Also, deployment descriptor 515 may be stored on the media to enable application server 513 to load and manage the various services that constitute the enterprise applications. The various services may include proxy service 514. The executable instructions defining the operations of proxy service 514 may also be stored on the media associated with storage devices 506.

Communications adapter 511 is adapted to couple computer system 500 to a network 512, which may be one or more of telephone network, local (LAN) and/or wide-area (WAN) network, Ethernet network, and/or Internet network. User interface adapter 508 couples user input devices, such as keyboard 513 and pointing device 507, to computer system 500. Display adapter 509 is driven by CPU 501 to control the display on display device 510.

By making a web service accessible through a proxy service, embodiments of the present invention may provide several advantages. In particular, the functionality of the web service may be invoked in a modular basis by multiple enterprise applications without requiring application developers to be aware of or understand the protocols associated with the web service. Instead, only one developer may implement those protocols for the proxy service. Thereafter, other developers may leverage the proxy service in the same manner as any other service. Moreover, embodiments of the present invention facilitate security management associated with web services. Specifically, the security management functionality of single process systems such as application servers are relatively well defined and understood. Embodiments of the present invention enable such known security management functionality to be utilized to manage web services with reduced complexity and increased reliability.

1. A method for providing a service in a controlled run-time environment, comprising:
registering a proxy service in said controlled run-time environment wherein said proxy service implements an interface defined according to said controlled run-time environment to enable services operating in said controlled run-time environment to interoperate with said service;
receiving service information by said proxy service from a local service executing in said controlled run-time environment via an interface method of said proxy service;
communicating said service information to a remote service from said proxy service;
receiving processed information from said remote service in response to said communicating; and
returning said processed information to said local service from said proxy service.

2. The method of claim 1 further comprising:
instantiating, by said controlled run-time environment, an object of a class that defines said proxy service.

3. The method of claim 2 further comprising:
instantiating, by said controlled run-time environment, said object in a partition; and
enabling, by said controlled run-time environment, only services operating in said partition to access said proxy service.

4. The method of claim 1 wherein said communicating service information comprises:
encapsulating said service information in an extensible mark-up language (XML) file.

5. The method of claim 1 further comprising:
exposing, by said controlled run-time environment, said proxy service only when access is permitted according to security parameters.

6. The method of claim 5 wherein said exposing comprises:
determining user-level authorization from said security parameters.

7. The method of claim 5 wherein said exposing comprises:
determining process-level authorization from said security parameters.

8. The method of claim 1 further comprising:
creating a log of access to said remote service.

9. The method of claim 1 wherein said communicating said service information comprises:
performing a remote procedure call.

10. A system for providing a modular software service, comprising:
controlled run-time environment means for managing processes;
service registry means for registering services operating in said controlled run-time environment means, wherein at least one registered service is a proxy service means;
said proxy service means implementing an interface defined according to said controlled run-time environment means for enabling services operating in said controlled run-time environment means to interoperate with said proxy service means, said proxy service means comprising:
means for receiving service information by said proxy service means from a local service executing in said controlled run-time environment means;
means for communicating said service information to a remote service from said proxy service means;
means for receiving processed information from said remote service in response to said communicated service information; and
means for returning said processed information to said local service.

11. The system of claim 10 wherein said proxy service means further comprises:
means for verifying said service information that is operable before said means for communicating.

12. The system of claim 10 wherein said proxy service means further comprises:
means for communicating with a distributed service registry to identify said remote service.

13. The system of claim 10 wherein said controlled run-time environment means instantiates said object in a partition and only permits services operating in said partition to access said proxy service.

14. The system of claim 10 where said controlled run-time environment means comprises:
security management means for exposing said proxy service only when said security management means determines access is permitted according to security parameters.

15. The system of claim 10 wherein said controlled run-time environment means comprises:
logging means for creating a log of access to said remote service.

16. The system of claim 10 wherein said means for communicating performs a remote procedure call.

17. A computer-readable medium that comprises executable instructions for providing a service in a controlled run-time environment, said executable instructions comprising:
code for registering a proxy service in said controlled run-time environment wherein said proxy service implements an interface defined according to said controlled run-time environment to enable services operating in said controlled run-time environment to interoperate with said service;
code for receiving service information by said proxy service from a local service executing in said controlled run-time environment via a method of said proxy service;
code for communicating said service information to a remote service from said proxy service;
code for receiving processed information from said remote service in response to said communicating; and
code for returning said processed information to said local service from said proxy service.

18. The computer-readable medium of claim 17 wherein said proxy service is an object of a class that is instantiated by said controlled run-time environment.

19. The computer-readable medium of claim 17 wherein said executable instructions further comprise:
code for verifying said service information before said code for communicating is operable.

20. The computer-readable medium of claim 17 wherein said executable instructions further comprise:
code for communicating with a distributed service registry to identify said remote service.
code for returning said processed infonnation to said local service from said proxy service. 18. The computer-readable medium of claim 17 wherein said proxy service is an object of a class that is instantiated by said controlled run-time environment. 19. The computer-readable medium of claim 17 wherein said executable instructions further comprise:
code for verifying said service information before said code for communicating is operable. 20. The computer-readable medium of claim 17 wherein said executable instructions further comprise: code for communicating with a distributed service registry to identify said remote service. 25388024.1
